(19) United States
(12) Patent Application Publication
(10) Pub. No.: US 2009/0304452 A1
(43) Pub. Date: Dec. 10, 2009

(54) Metal Piles or Dolphins with Ballastable Skirts

(76) Inventor: Jean-Claude Bernadac, Courbevoie (FR)

Correspondence Address: COLLARD & ROE, P.C., 1077 NORTHERN BOULEVARD, ROSLYN, NY, 11576, US

(21) Appl. No.: 12/309,012

(22) PCT Filed: Jun. 29, 2007
(86) PCT No.: PCT/FR2007/051571

§ 371 Date: Dec. 31, 2008

(30) Foreign Application Priority Data
Jul. 1, 2006 (FR) 0652761

(51) Int. Cl. E02B 17/08; E02D 5/22; F16C 11/00; F16C 29/02; B23P 11/00

(52) U.S. Cl. 405/196; 405/231; 403/122; 384/29; 29/428

(57) ABSTRACT

The invention relates to a metal pile or dolphin (11), a floating pontoon or floating pontoon element being intended to be held in place by one or more of these metal piles or dolphins (11). A ballastable mobile skirt is associated with said pile or dolphin and consists of a tube (1) having a diameter slightly smaller than that of the pile or dolphin (11) which is intended to receive it in order to allow it to slide vertically inside said pile or dolphin, said tube (1) being closed at its upper end so that the volume of air trapped inside it provides sufficient buoyancy to allow it to follow, in the use position, the rising and falling movements of the water or tides, whilst still allowing its top (2) to protrude above the water in order to enable the latter to be fastened to the underside of said floating pontoon or floating pontoon element to be installed, so that the weight of the skirt is not borne thereby.

The present invention relates to the field of generally circular, driven metal piles, or dolphins, used especially for holding in place floating pontoons, in particular in the docks of marinas, seaports, river ports, waterways, etc.

In most cases, the afloat parking of boats in marinas is by way of booms made of several floating pontoons held in position by metal piles or “dolphins” placed in the ground of bottoms of docks.

While holding in position floating mooring pontoons, these piles also allow the latter, thanks to frames forming slides, to follow the motion of water or of tides, by rising and falling along the piles.

The mooring assembly according to the international PCT application WO2005058683, based on the displacement of mooring booms along with the boats being moored to them, also uses piles for controlling the motions of the traction members enabling these displacements. The space dedicated in each traction member to enable its displacement around the pile requires a removable protection and/or structure perpendicularly to the traffic of users for their safety.

As for conventional pontoons, these piles are usually laterally fastened to the floating pontoons, via slides, and their hold hinders the mooring spaces distribution optimization in usually already overcrowded ports.

In order to mitigate this problem, some wharf installers settle the wharfs directly on the piles, which then pass through the pontoons. In this case, in order not to hinder the traffic of users on the booms, these pontoons have a width greater than that of the conventional pontoons, equivalent to the hold of the piles, generating again a loss of surface.

Lastly, some historical ports refuse to set up dolphins, putting forward the aesthetical nuisances created by their proliferation.

An object of the present invention is to overcome these drawbacks in docks, and more particularly in the ones that do not have a too important tidal range, but without being limited to the latter. To this end, there is provided a new device to be added to the conventionally designed piles so that the piles remain invisible, by being concealed under the pontoons.

The setting up of conventional circular metal piles is still necessary according to the present invention, but these piles are set up until they are flush with the lowest possible water level, namely, for the sea, the level known as “low water” or the lowest level of “spring tides” corresponding to the tides having the greatest tidal range. Therefore, these are in general piles having a length far less important that that of conventional piles, the latter still having to rise above the level known as “high water” or the highest level of tides, still in “spring tides”.

According to the present invention, the inside of each pile is skirted using a tube, especially a metal or synthetic material tube, having a diameter slightly smaller to that of the pile which receives it, in order to allow it to vertically slide inside the pile. This tube is blocked at its upper end so that the volume of air trapped inside can provide it with sufficient buoyancy to allow it to follow the rising and falling movements of water or tide, whilst always allowing its top to protrude a certain height above the water level in order to enable the fastening of the top, advantageously via a cardan mount, to the underside of the floating pontoons or floating pontoon elements, so that these do not have to bear the weight of the skirt.

The height adjustment of the protrusion above the water of the top according to the invention is achieved through “ballasting” by decreasing or increasing the volume of inside air using an (adjustable) one-way air valve. This ballasting is done upon the first installation, a monitoring then having to be done on a regular basis.

The tube length of the skirt subject-matter of the present invention is calculated to allow the absorption of the water level differences varying according to the tides.

Based on the geological nature of the bottom of the concerned docks, the conventional piles will be more or less deeply driven. This driving will allow, after drilling inside the pile to drain the residual materials to the driving level and after the setting up of a mooring buoy acting as a plug in the bottom of the pile, the body of the skirt to go down lower than the bottom of the concerned dock.

The upper part or top of the ballastable skirt is advantageously provided with a cardan mount, intended to absorb the small pitching and rolling motions which occur inside docks, which allows the fastening of the sliding carriage, placed under the floating traction members Mobi-Deck, which are the subject-matter of the international PCT application WO2005058683, without the pile protruding above the movable decking of the traction pontoon.

The cardan mount similarly allows the fastening, to the underside, of the structure of conventional type floating pontoons.

DE-U-298 14 581 discloses a floating system provided with non ballastable suspended skirts 2, which vertically slide in piles 1 driven in the ground. These skirts 2 are suspended from the floating pontoon 9 via a non-articulated transverse carrier 4.

The skirts may be closed at their two opposite faces. Accordingly, one can assume that they are filled with air, so that it is the weight of the floating pontoon that keeps them immerged.

They may also be opened at their both ends, the hooking to the floating pontoon preventing them from sinking. In this last case, the weight of the skirts is entirely borne by the floats of the floating pontoon, and the volume of the floats has to be calculated in order to take into account this additional weight.

To sum up, in the case of the installation described in DE-U-298 14 581, if the skirts are closed at both ends, the weight of the pontoon must be great, and on the contrary, if they are opened at both ends, the pontoon buoyancy must be reinforced to bear the additional weight of the skirts.

The pontoon has therefore to be adapted in each case, which complicates the installation.

The present invention solves this double problem with a ballastable skirt whose top can protrude above the water level.

The fact that the top protrudes from the water allows the cardan mount not to be immerged and therefore to be less prone to corrosion.

A first subject-matter of the present invention is therefore a metal pile or dolphin, a floating pontoon or a floating pontoon element being intended to be held in position by one or more of these metal piles or dolphins, characterized in that a ballastable mobile skirt is associated to said metal pile or dolphin, said ballastable mobile skirt consisting of a tube having a diameter slightly smaller than that of the pile or dolphin which has to receive it in order to allow it to vertically slide inside said pile or dolphin, said tube being closed at its upper end so that the volume of air trapped inside it provides it with sufficient buoyancy to allow it to follow, in use position, the rising and falling movements of water or tide, whilst still allowing its top to protrude above the water level in order to enable the top to be fastened to the underside of said floating pontoon or floating pontoon element to be held in position.

According to an interesting embodiment of the present invention, the space between the skirt, subject-matter of the invention, and the conventional pile is calculated to allow the water contained in the pile to be flushed outside when the skirt descends with the water level (tide) or to allow the water to fill the conventional pile when the skirt rises; this is the reason why this skirt can only be placed inside the pile.

According to a particularly interesting feature of the pile according to the present invention, the length of the hollow tube of said skirt is selected according to the height of the tides in the installation location of said pile or dolphin so that said skirt always floatingly protrudes a constant height above the water level, which height is adjusted by the ballasting in order to satisfy the needs of the hooking system on the floating pontoon or floating pontoon element to be held in position, so that the weight of the skirt is not borne by the floating pontoon or floating pontoon element.

According to a particularly preferred embodiment, the ballastable mobile skirt is provided with an adjustable one-way air valve allowing to decrease or increase the volume of inside air in order to provide, through ballasting, the height adjustment of the protrusion of the top of the skirt above the water level, said one-way air valve being advantageously provided on the upper end of the hollow tube. The decrease of the volume of air is done by purging, and the increase of the volume of air is done using a compressor that supplies air inside through the one-way air valve.

The upper part of the ballastable mobile skirt may carry means complementary to means carried by the floating pontoon underside or by a device cooperating with the pontoon underside for its fastening, said means and said complementary means consisting advantageously of a cardan mount intended to absorb the small pitching and rolling motions that may occur inside the docks, sea ports, river ports or lake basins.

Besides, the outer wall of the hollow tube of the ballastable mobile skirt may carry, protruding thereof, longitudinal seals for the sliding of the hollow tube in said pile or dolphin, said seals being advantageously regularly spaced on the periphery of said hollow tube, and said seals being especially of the water self-lubricating type.

The ballastable mobile skirt according to the present invention is advantageously provided with retaining means for a cooperation with complementary means carried by said metal pile or dolphin in order to prevent an accidental complete driving of said mobile skirt inside said pile or dolphin. The skirt body may be closed at its upper part by a platen that has an overhang on at least part of its periphery, said overhang being adapted to abut against the free upper border of the pile or dolphin in order to prevent the accidental complete driving of the skirt inside said pile or dolphin.

Moreover, the length of the hollow tube of said ballastable mobile skirt is advantageously selected according to the need to have a hollow tube height h driven in the pile or dolphin in order to maintain a good axial retention at high water, said height h amounting especially to at least ⅖ of the tube in contact with the inside of said pile or dolphin.

Furthermore, the ballastable mobile skirt is advantageously provided with retaining means intended to cooperate with complementary means carried by the pile or dolphin in order to prevent the hollow tube of the skirt from leaving said pile or dolphin on a contact height smaller than the selected height h, in order to avoid an accidental exit from the body of the receiving pile.

Said retaining means and said complementary retaining means are especially composed of at least one ring or bail externally fastened to the upper part of the hollow tube of the skirt, and of at least one ring or bail externally fastened to the pile or dolphin, a ring or bail carried by said hollow tube being connected to the corresponding ring or bail by a chain whose length is selected so that, in fully extended position, the hollow tube of the skirt remains always driven of the selected height h into the pile or dolphin.

Another subject-matter of the present invention is a ballastable mobile skirt to be associated to the metal pile or dolphin as described above.

Another subject-matter of the present invention is a method of installing into the bottom of a dock a pile or dolphin with its associated ballastable mobile skirt as described above, characterized in that it comprises the steps of:
imbedding the pile, for example through hammering or other conventional positioning means according to the topology of the ground, into the bottom of the dock, the river port or lake basin, the pile having such a height that it is flush with or protrudes above the sea level known as low water and as spring tide;
if necessary, drilling inside the conventional pile to remove the residual materials therein and immerse a mooring buoy, made of concrete or similar material, forming a plug, in the bottom of the well thus formed and delimited by the inner wall of the pile and the drilling limit, in order to avoid any rise of sludge, sand or similar, inside the pile; and
axially sliding the ballastable mobile skirt in the upper part of the pile and adjusting the height, via ballasting, of the protrusion of the top of the skirt above the water level.

Particularly, a drilling step will be performed if the height of the skirt, taking into account the tide range of the relevant location, has to be greater than that of the conventional pile being flush with the low water level.

Another subject-matter of the present invention is an harbour facility comprising piles or dolphins each provided with its ballastable mobile skirt, as defined above, a floating pontoon being fastened to the plurality of ballastable mobile skirts, advantageously via cardan mounts.

According to a first embodiment of the harbour facility according to the present invention, the floating pontoon is a fixed pontoon (i.e., positioned once and for all).

According to a second embodiment of the harbour facility according to the present invention, the floating pontoon element is a floating mobile system adapted to drive, through its displacement, a mobile boom which is part of a set of mobile booms parallel to each other, each boom being provided with at least one said floating pontoon system, said booms being adapted to close upon each other by mutually hooking ends of the floating mobile systems and to move away from each other in order to leave a manoeuvre way between two of them for the entry and exit of boats in the harbour facility, each floating mobile system being provided with a guide rail fastened to the underside thereof, cooperating with a carriage fastened to the upper part of the ballastable mobile skirt, advantageously via a cardan mount.

Such floating mobile systems are described in the international patent application PCT WO2005058683.

In order to better illustrate the subject-matter of the present invention, several embodiments will be described below, by way of indication and in a non-limitating way, with reference to the appended drawings, on which:

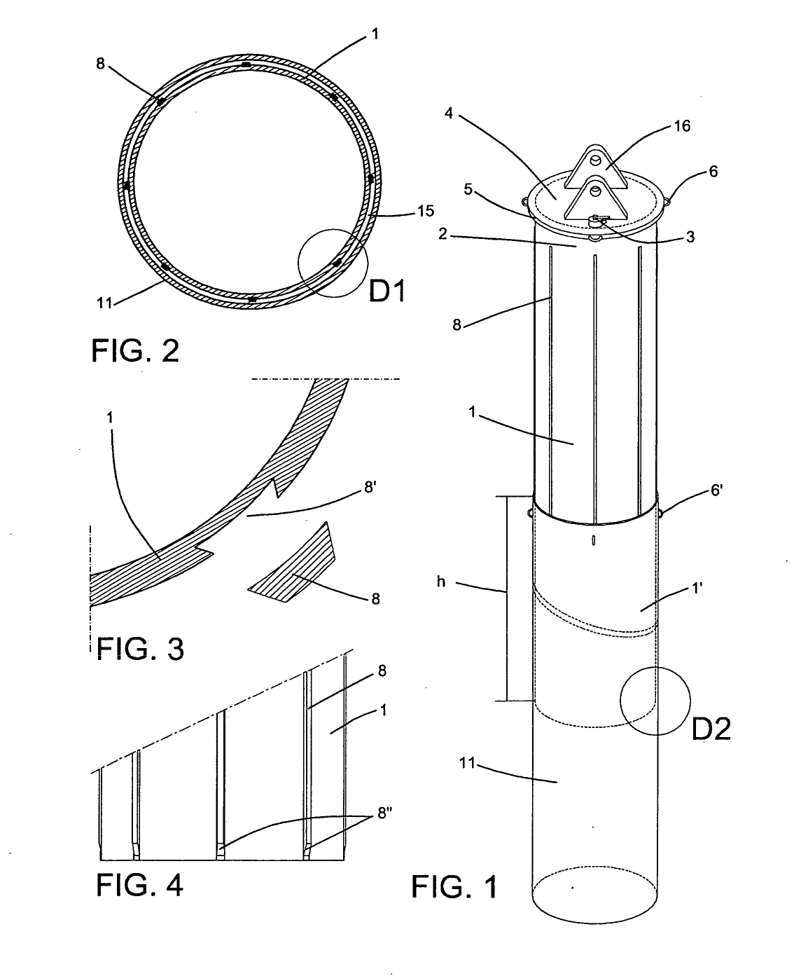

FIG. 1 is an axonometric view of a ballastable mobile skirt in accordance with a particular embodiment of the present invention, in a position partially introduced in a conventional pile;

FIG. 2 is, at enlarged scale, a transverse cross-section view according to II-II of FIG. 5;

FIG. 3 is, at further enlarged scale, an exploded transverse cross-section view of the body of the ballastable mobile skirt according to the invention, according to Detail Dl of FIG. 2;

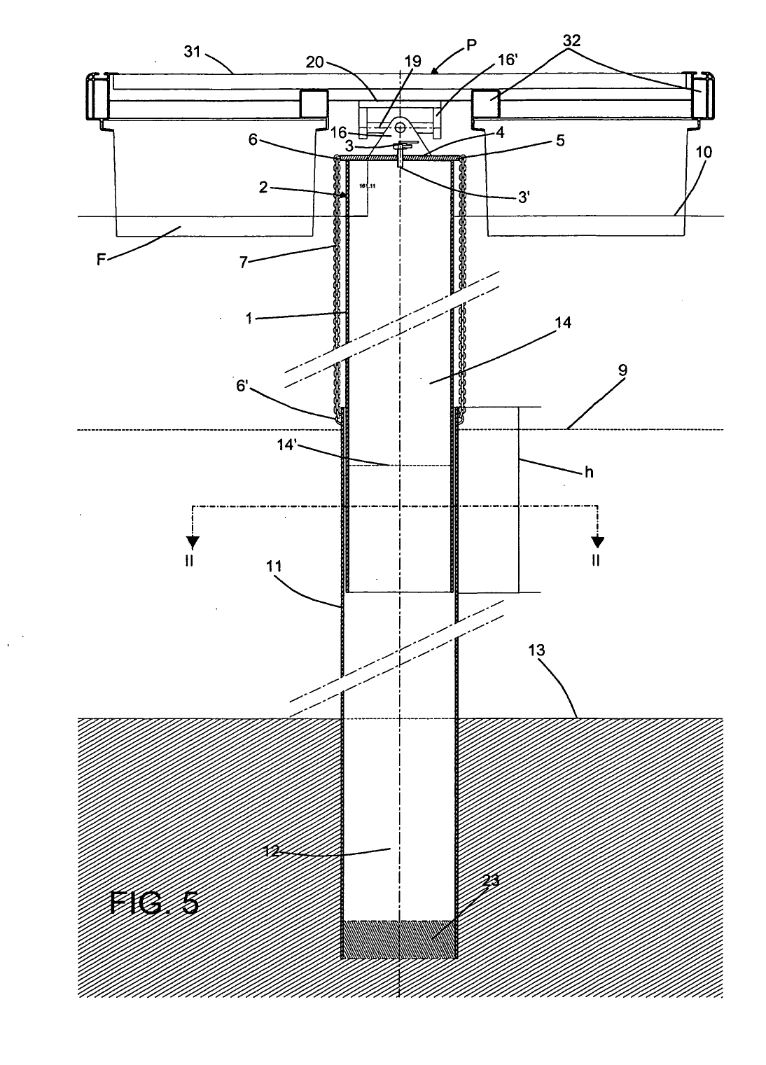

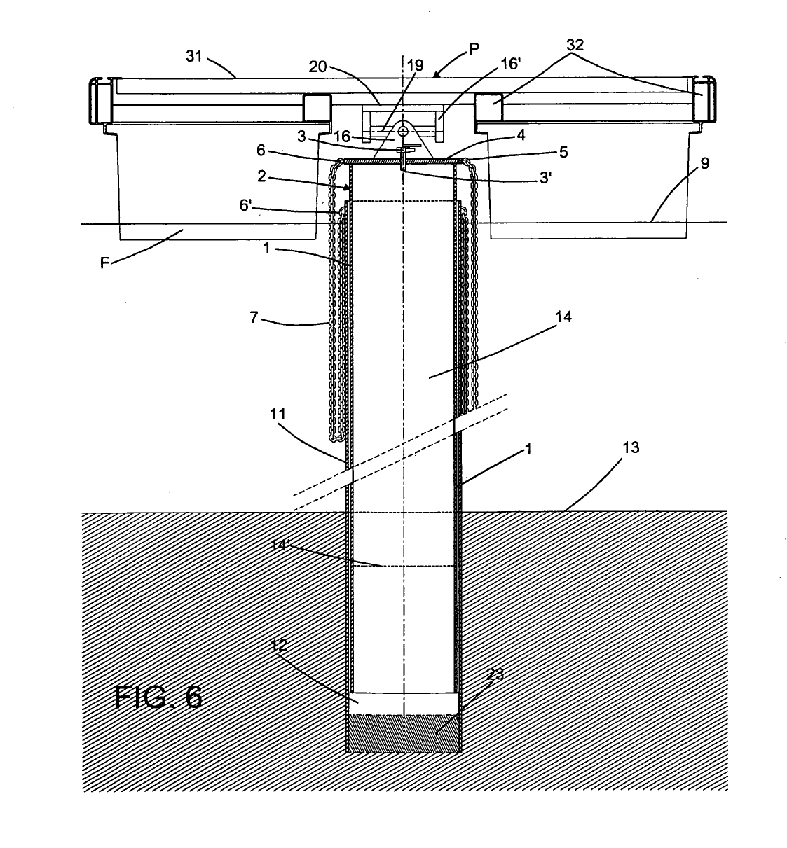

FIG. 4 is, at enlarged scale, an partial elevation view of the body of the skirt of the invention, showing the lower part of the body, according to Detail D2 of FIG. 1;

FIGS. 5 and 6 show, in axial cross-section, at high water and at low water respectively, the ballastable mobile skirt of the invention that is embedded in a conventional pile and whose upper part or top is fastened to a conventional pontoon;

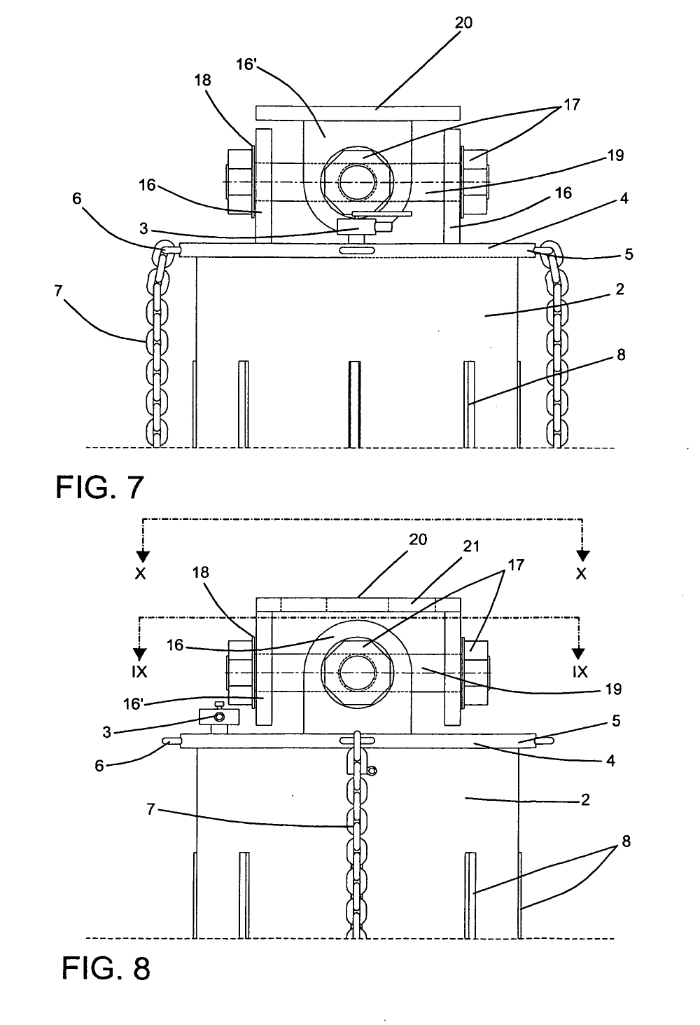

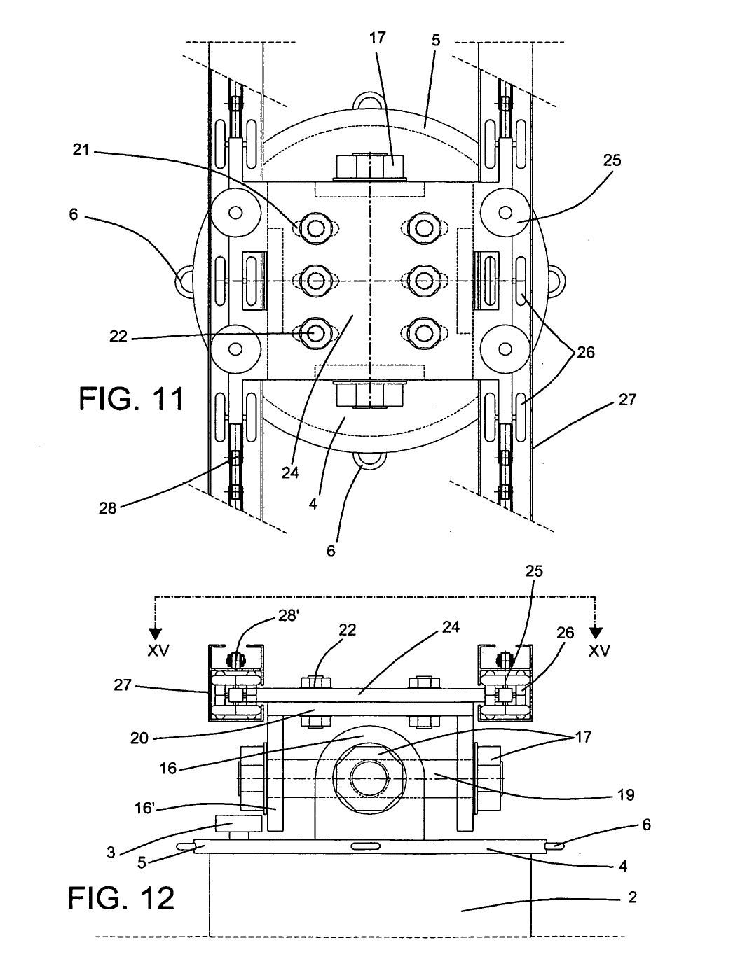

FIG. 7 is an elevation view of the top of the ballastable mobile skirt of the invention, on which is mounted a cardan mount intended to provide a connection with at least one conventional pontoon such as shown on FIGS. 5 and 6 or with a carriage of the type described in the international PCT application WO2005058683 (FIGS. 11 to 18);

FIG. 8 is a view similar to FIG. 7, with the skirt rotated a quarter of a turn about its axis;

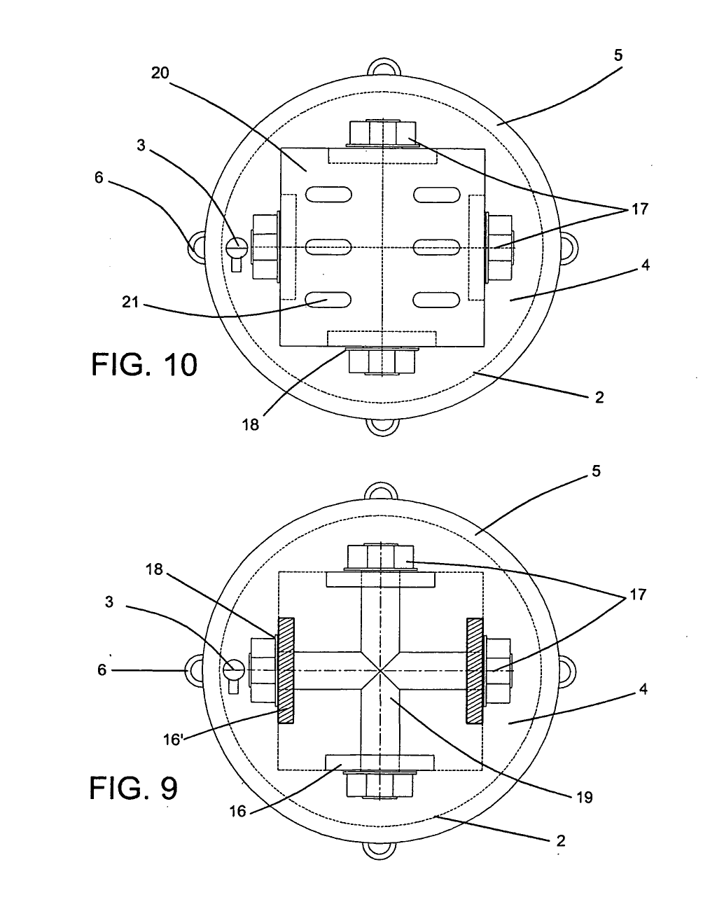

FIG. 9 is an horizontal cross-section view according to IX-IX of FIG. 8;

FIG. 10 is a top plan view according to X-X of FIG. 8;

FIG. 11 is a top view corresponding to FIG. 10, on which a carriage system having two guiding rails has been represented;

FIG. 12 is an elevation view of the upper part or top of the invention corresponding to FIG. 8, on which said carriage system having two guiding rails has been represented;

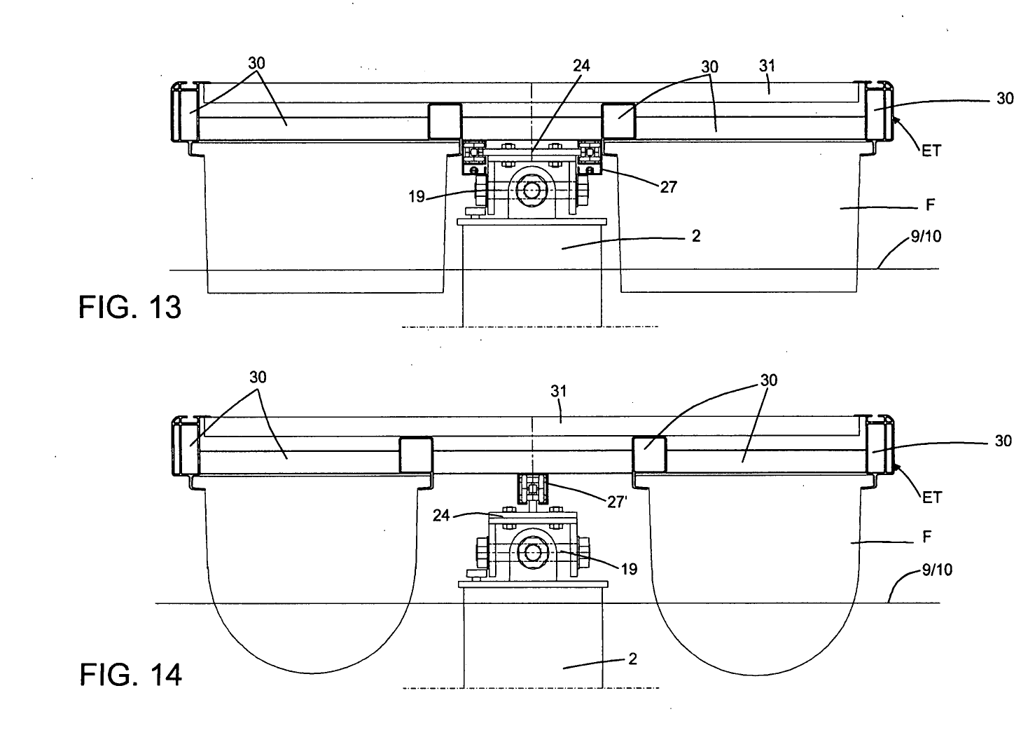

FIG. 13 is a view corresponding to the upper part of FIGS. 5 and 6, showing the top of the skirt of FIGS. 7 to 10, as well as the carriage system having two guiding rails of FIGS. 11 and 12, which carriage system carries a traction floating pontoon;

FIG. 14 is a view corresponding to FIG. 13 of a carriage system alternative having only one guiding rail;

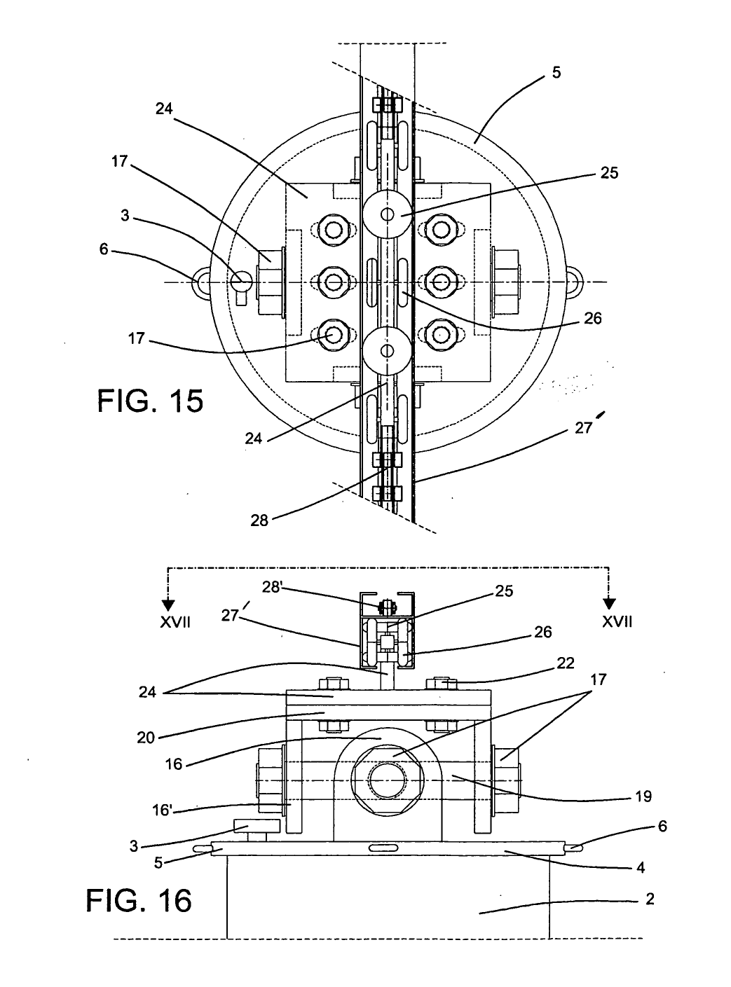

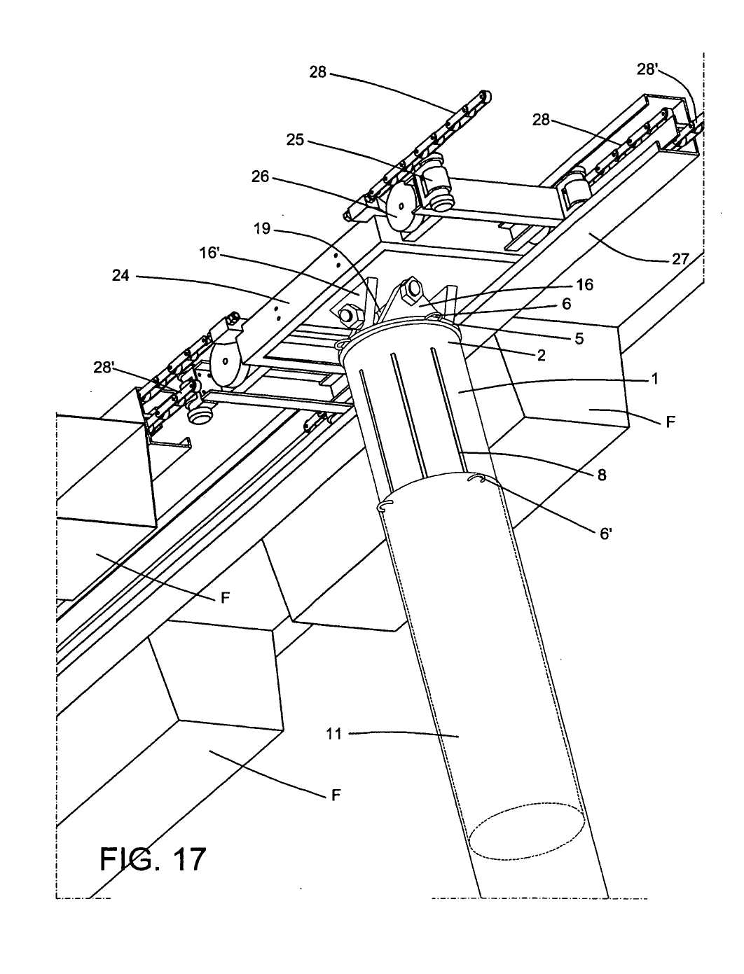

FIGS. 15 and 16 are views corresponding to FIGS. 11 and 12 respectively, for the carriage alternative having one guiding rail of FIG. 14;

FIG. 17 is an axonometric view illustrating the hooking, on a pile having a ballastable skirt according to the invention, of a traction floating pontoon carrying two side guiding rails according to FIGS. 11 to 13, the pile being seen from the bottom and cut away parts being performed in the guiding rails to show the detail of this hooking; and

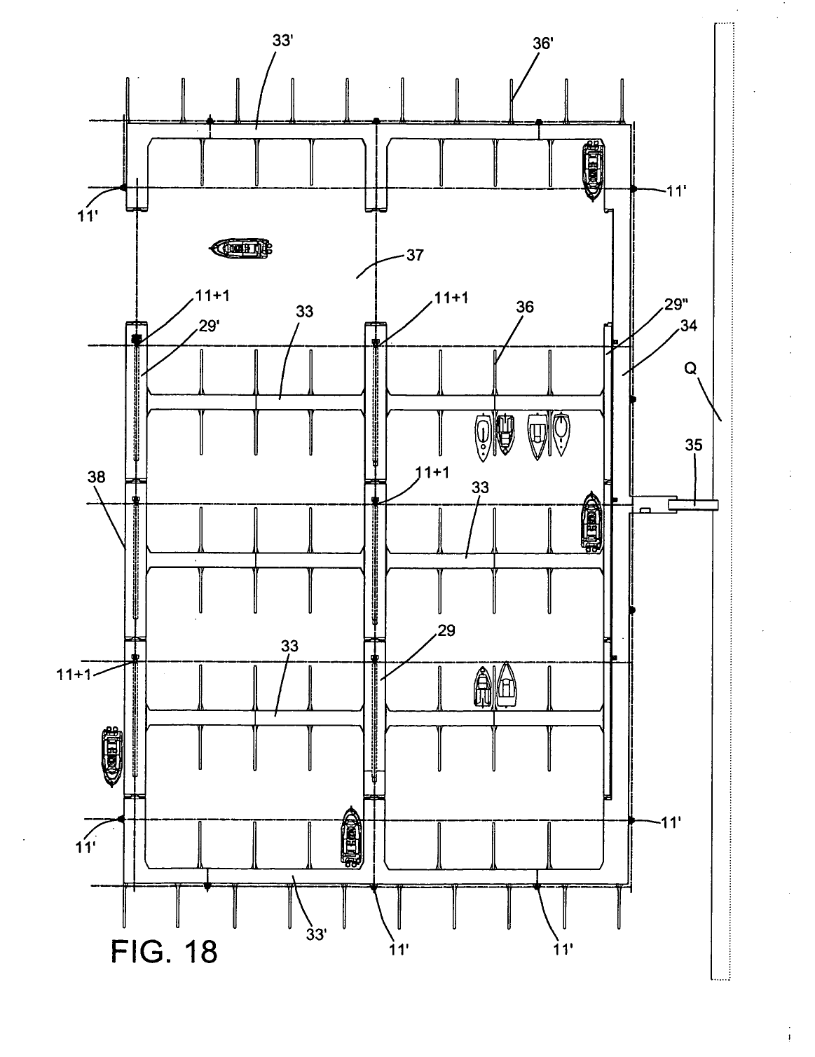

FIG. 18 is a schematic plan view of an harbour module Mobi-Deck implemented according to the principle described in the aforementioned international PCT application and composed of a mooring assembly that is provided with such boom moving traction floating pontoons.

In FIG. 1, it can be seen that a ballastable mobile skirt according to the invention has been represented in an axonometric view, the lower part 1′ of the skirt being embedded in a conventional pile 11, which pile is made of a cylindrical tube opened at its both ends.

The ballastable mobile skirt, slidably mounted in a conventional cylindrical hollow pile 11, is composed of an hollow cylindrical tube or body 1 opened at its lower end, when considering the use position (this applies to the following description), and closed at its upper end by a disc-shaped platen 4. The diameter of the platen 4 is greater than the outer diameter of the pile 11, in order to form an annular circumferential safety overhang intended to abut against the upper circular border of the pile 11 in extraordinary circumstances, such as a derangement of the ballasting, as will be described later; thus, the overhang 5 acts as a retaining means so that the skirt of the invention cannot be accidentally driven inside the pile 11. The platen 4 is fastened to the body 1 by any suitable means, such as welding, etc.

The body 1 and the platen 4 are made of metal or metal alloy or stiff synthetic material.

On the platen 4 are mounted, on the one hand, adjacent to the edge of the platen 4, a ballasting valve 3 whose purpose will be described in more detail thereafter, and, on the other hand, the lower flanges 16 of the cardan connection mount that will also be described in more detail thereafter.

Retaining rings or bails 6 (four in the represented example) are fixed to the side edge of the upper platen 4, which are regularly spaced at the periphery of the platen 4 and in line with identical retaining rings or bails 6′ fixed to the outer wall of the conventional pile 11; the rings or bails 6, 6′ are fixed to the platen 4 and to the pile 11 respectively by any known means, such as welding, etc.

As can be especially seen on FIGS. 5 to 8, the rings (or bails) 6 and 6′ are connected by safety retaining chains 7 whose length is selected so that, in fully extended position, the hollow body 1 remains always driven a selected height h in the cylinder 11.

Dovetail-profiled recesses 8′ are formed along the outer wall of the body 1 of the ballastable skirt of the invention, which recesses are regularly spaced at the periphery of said body (FIG. 3). A sliding seal 8 is forcibly inserted in each of these recesses, the sliding seal 8 having a corresponding trapezoid profile and being of the water self-lubricating type, such as the ones known as “hydrolube seals”.

The seals extend from the lower border of the pile 11 to the vicinity of its upper part. The seals 8 ends in the lower border into a bevel portion 8″ as can be seen on FIG. 4. This bevel configuration allows an easier guiding when inserting the skirt according to the invention in the conventional pile.

In FIG. 2, in the embedded position of the skirt of the invention in the conventional pile 11, the space 15 between the outer face of the skirt of the invention and the inner face of the pile, as well as the configuration of the vertical sliding seals 18 in this space 15 can be seen. This space 15, between the skirt subject-matter of the present invention and the conventional pile, also allows the water contained therein to be flushed outside when the skirt goes down with the water level (tide) or to fill the conventional pile when the skirt rises.

It can also be seen in FIG. 1 that the upper part or top of the ballastable skirt of the present invention has been designated by the reference numeral 2.

The laying of the metal pile 11 and the installation of the ballastable mobile skirt according to the invention will now be described, again with reference to FIGS. 5 and 6.

The pile 11 is positioned, in general by hammering at low water, in the bottom 13 (FIGS. 5 and 6) of the dock. The pile 11 has such a height that it protrudes a desired level above the water level at low water (level designated by the reference numeral 9 on FIGS. 5 and 6).

Then, according to the tidal range heights and the depth of the dock at low water in the installation site, a drilling is, if necessary, performed inside the pile 11 using a drill bit, to remove the materials therein down to the driving level of said pile, and a concrete mooring buoy 23 is immersed in the bottom of the well so formed and delimited by the inner wall of the pile 11 and the drilling bottom, in order to avoid any rise of sludge, sand or other, inside the well. The reference numeral 12 designates the part of the pile 11 driven into the bottom 13 of the dock.

Then, the skirt according to the invention is axially slidably set up by the emerged upper part of the pile 11 and the protrusion height of the top 2 of the skirt above the water level is adjusted by ballasting using said valve 3 to the necessary protrusion height. The reference numeral 3 refers to the valve itself, communicating with the inside of the skirt. When driving the pile 11, water has penetrated in the inner space thereof and has hence remained above the plug 23, this theoretical height of water being referenced 14′. When installing the skirt, air is therefore trapped in the upper part thereof, which air will act as a ballast for the skirt and has therefore to be regulated to provide the buoyancy enabling the top to protrude at a constant height. This air supply is designated by the reference numeral 14.

It is also possible to operate, with adapted equipment, at various heights of tide provided that the pile is positioned so as to always protrude or be flush with the low water level of spring tide or tides having a greater tidal range.

The length of the hollow body 1 of the skirt depends on:
the height of the tides in the concerned location, so that said skirt always floatingly protrudes a constant height above the water level, which height is set once and for all, by the ballasting in order to satisfy the needs of the hooking system on the pontoon; indeed, the freeboard (pontoon height above the water) is determined according to the use of the pontoon; and
the need to always allow to have a hollow body 1 height h driven in the pile 11, in order to maintain a good axial hold at high water.

FIGS. 5 and 6 show the ballastable skirt according to the present invention, embedded in the conventional pile at high water (indicated by the line 10) and at low water (indicated by the line 9) respectively. The safety retaining chains 7 are in extended position at high water to prevent the skirt according to the invention from accidentally leaving the conventional pile 11, and in slackened position at low water.

It can be noted that, at the low water position of FIG. 6, the lower part of the body 1 descends lower than the bottom 13 of the dock, which is advantageous in circumstances that will be described thereafter.

A pontoon P has also been shown in FIGS. 5 and 6, which pontoon will not be described in detail as it is a conventional one.

However, it can be seen that it is composed of a load-bearing structure 32 on which a movable decking 13 is installed and under which floats F are provided.

The pontoon P is fastened to the platen 4 of the skirt by a cardan mount whose crucial axis 19 is conventionally carried by said parallel lower flanges 16 carried by the platen 4 and parallel upper flanges 16′ carried by the pontoon P, arranged at 90° with respect to the lower flanges 16.

The assembly of the cardan mount has been represented in greater details on FIGS. 7 to 9. The locking nuts 17 and the lockwashers associated to the crucial axis 19 for fastening the latter to the flanges 16 and 16′, as well as the upper platen 20 (FIGS. 7 and 8) of the cardan to which are perpendicularly fastened the upper flanges 16′ can thus be seen. This platen 20 is a square in the represented example.

In FIG. 10, oblong holes 21 can be seen, which have to be regarded for the embodiment of FIGS. 5 and 6 according to which the skirt of the invention cooperates with a conventional pontoon P, but particularly for the embodiments of FIGS. 11 to 18 which will be now described and are commercially available under the registered trademark Mobi-Deck, being described in the international PCT application. These oblong holes 21 whose axis are parallel to an edge of the platen 20 are arranged here into three parallel rows.

In order to remind the Mobi-Deck technique, one can first refer to FIG. 18 which is a plan view of a dock equipped with the Mobi-Deck systems.

On this figure, a fixed pontoon known as “collecting pontoon” 34 can be seen, connected by a walkway 35 to the pier Q and parallel thereto. Two fixed end booms 33′ project from this collecting pontoon 34, in a direction perpendicular thereto, which fixed end booms, in conjunction with the pontoon 34, delimit the Mobi-Deck module of the dock thus equipped. Between these two fixed booms 33′ are provided, parallel thereto, mobile booms 33 (three in the represented example), which are intended to move parallelly to each other so as to be able to form on demand a single entry and exit area for boats or opened manoeuvre area 37 between these two booms 33 or between the boom 33′ and the neighbouring boom 33. To this end, the booms 33 carry traction members, namely, for each boom, a traction member 29″, or “pier” member, at least one intermediate traction member 29 (only one in the represented example) and a traction member 29′, or “top” member. These members 29, 29′ and 29″ are extended motorised structures perpendicular to the booms 33.

The pier traction members 29″ are slidably mounted along the inner edge of the collecting pontoon 34 and each other intermediate and top traction member is slidably mounted along a carriage carried by a ballastable mobile skirt 1 according to the invention.

The outer edge 38 of each top traction member 29′ forms a waiting pontoon section for the boats entering into the Mobi-Deck module of the dock.

The traction members are adapted to cooperate with each other via their ends, mutual hooking means being provided for that purpose. The booms are thus always hooked to each other via these means, apart from the two booms that are moved away from one each other in order to create a manoeuvre area 37. Besides, each mobile boom 33 adjacent to a fixed boom 33′ cooperates with fixed side arms thereof which carry an identical hooking system.

The piles 11 on which the ballastable mobile skirts 1 are mounted are provided in the bottom of the dock following a regular grid pattern. Conventional piles 11′ allow the hooking of the fixed collecting pontoon 34 and the fixed booms 33′.

Each boom 33 and 33′ conventionally carries, on both sides thereof, mooring arms or “catways” 36, 36′ respectively. The end regions of the floating mobile systems 29, 29′, 29″ also act as mooring arms for boats.

It can be seen in FIG. 17, from the bottom, a carriage 24 and its horizontal bearings 25 and its vertical bearings 26 that move in guiding rails 27 driven by traction chains 28 and their return 28′.

This embodiment, according to which the carriage 24 is provided with two side bearing systems 25 and 26 cooperating with two rails 27 integral with the structure 30 of a floating mobile system 29 (or 29′), is also illustrated in FIGS. 11, 12 and 13. It corresponds to the embodiments described in the aforementioned international PCT application.

An embodiment with a carriage having only one rail, with a similar operation, is thereafter described with reference to FIGS. 14 to 16.

In FIGS. 11 to 13, it can be seen that the carriage 24 is fastened using fasteners 22 on the upper platen 20 of the cardan mount. The fastening oblong holes 21 allow the adjustment of the carriage position in order to compensate the positioning tolerances of the piles 11.

FIG. 13 shows the structure 30 of the floating mobile system or traction member ET receiving a movable decking 31 that entirely covers said structure 30. Implementing the floating mobile systems ET is therefore greatly facilitated in comparison to the ones described in the aforementioned international PCT application, in which protection of the users was provided either by a decking divided in two parts windable on themselves or by a guard rail installed on the periphery of the area where the dolphin had to go through the floating mobile system.

In the embodiment with a monorail carriage of FIGS. 14 to 16, the guiding monorail 27′ moves, driven by the traction chain 28, over the carriage 24, the vertical bearings 26 and the horizontal bearings 25 being mounted along a centreline of said carriage 24.

It is understood that the embodiments which have been described above are indicative only and not limitating and that modifications can be done without departing from the scope of the present invention.

1. Metal pile or dolphin, a floating pontoon or a floating pontoon element being intended to be held in position by one or more of these metal piles or dolphins, wherein a ballastable mobile skirt is associated to said metal pile or dolphin, said ballastable mobile skirt consisting of a tube having a diameter slightly smaller than that of the pile or dolphin which has to receive it in order to allow it to vertically slide inside said pile or dolphin, said tube being closed at its upper end so that the volume of air trapped inside it provides it with sufficient buoyancy to allow it to follow, in use position, the rising and falling movements of water or tide, whilst still allowing its top to protrude above the water level in order to enable the top to be fastened to the underside of said floating pontoon or floating pontoon element to be held in position.

2. Metal pile or dolphin according to claim 1, wherein the space between said skirt and the conventional pile is calculated to allow the water contained in the pile to be flushed outside when the skirt descends with the water level or to allow the water to fill the conventional pile when the skirt rises.

3. Metal pile or dolphin according to claim 1, wherein the length of the hollow tube of said skirt is selected according to the height of the tides in the installation location of said pile or dolphin, so that said skirt always floatingly protrudes a constant height above the water level, which height is adjusted by the ballasting in order to satisfy the needs of the hooking system on the pontoon or pontoon element to be held in position, so that these do not bear the weight of the skirt.

4. Metal pile or dolphin according to claim 1, wherein said skirt is provided with an adjustable one-way air valve allowing to decrease or increase the volume of inside air in order to provide, through ballasting, the height adjustment of the protrusion of the top of the skirt above the water level, said one-way air valve being advantageously provided on the upper end of the hollow tube.

5. Metal pile or dolphin according to claim 1, wherein the upper part of said skirt carries means complementary to means carried by the pontoon underside or by a device carried by or cooperating with the pontoon underside for its fastening, said means and said complementary means consisting advantageously of a cardan mount intended to absorb the small pitching and rolling motions that may occur inside the docks, seaports, river ports or lake basins.

6. Metal pile or dolphin according to claim 1, wherein the outside wall of the hollow tube of said skirt carries, protruding thereof, longitudinal seals for the sliding of the hollow tube in said pile or dolphin, said seals being advantageously regularly spaced on the periphery of said hollow tube, and said seals being especially of the water self-lubricating type.

7. Metal pile or dolphin according to claim 1, wherein said skirt is provided with retaining means for cooperation with complementary means carried by said metal pile or dolphin in order to prevent an accidental complete driving of said mobile skirt inside said pile or dolphin, wherein the body of said skirt may be closed at its upper part by a platen that has an overhang on at least part of its periphery, said overhang being adapted to abut against the free upper border of the pile or dolphin in order to prevent the accidental complete driving of said skirt inside said pile or dolphin.

8. Metal pile or dolphin according to claim 1, wherein the length of the hollow tube of said skirt is selected according to the need to have a hollow tube height h driven in the pile or dolphin in order to maintain a good axial retention at high water, said height h amounting especially at least to ⅖ of the tube in contact with the inside of said pile or dolphin.

9. Metal pile or dolphin according to claim 1, wherein said skirt is provided with retaining means intended to cooperate with complementary means carried by the pile or dolphin in order to prevent the hollow tube of the skirt from leaving said pile or dolphin on a contact height smaller than the selected height h, wherein said retaining means and said complementary retaining means are especially composed of at least one ring or bail externally fastened to the upper part of the hollow tube of the skirt, and of at least one ring or bail externally fastened to the pile or dolphin, a ring or bail carried by said hollow tube being connected to the corresponding ring or bail by a chain whose length is selected so that, in fully extended position, the hollow tube of the skirt remains driven of selected height h into the pile or dolphin.

10. Ballastable mobile skirt to be associated to the metal pile or dolphin as defined in claim 1.

11. Method of installing into the bottom of a dock a pile or dolphin with its associated ballastable mobile skirt, as defined in claim 1, wherein it comprises the steps of:
imbedding the pile into the bottom of the dock, the river port or the lake basin, the pile having such a height that it is flush with or protrudes above the sea level known as low water and as spring tide;
if necessary, drilling inside the conventional pile to remove the residual materials therein and immerse a mooring buoy, made of concrete or similar material, forming a plug, in the bottom of the well thus formed and delimited by the inner wall of the pile and the drilling limit, in order to avoid any rise of sludge, sand or similar, inside the pile; and
axially sliding the ballastable mobile skirt in the emerged upper part of the pile and adjusting the height, via ballasting, of the protrusion of the top of the skirt above the water level.

12. Harbor facility comprising piles or dolphins each provided with its ballastable mobile skirt, as defined in claim 1, a floating pontoon or floating pontoon element being fastened to the plurality of ballastable mobile skirts, advantageously via cardan mounts.

13. Harbor facility according to claim 12, wherein the floating pontoon is a fixed pontoon (P).

14. Harbor facility according to claim 12, wherein the floating pontoon element is a floating mobile system adapted to drive, through its displacement, a mobile boom being part of a set of mobile booms parallel to each other, each boom being provided with at least one said floating pontoon element, said booms being able to close upon each other by mutually hooking ends of the floating mobile systems and to move away from each other in order to leave a manoeuvre way between two of them for the entry and exit of boats in the harbvur harbor facility, each floating mobile system being provided with at least a guiding rail fastened to the underside thereof, cooperating with a carriage fastened to the upper part of the ballastable mobile skirt, advantageously via a cardan mount.
